(19) United States
(12) Patent Application Publication
(10) Pub. No.: US 2025/0313047 A1
(43) Pub. Date: Oct. 9, 2025

(54) RETREAD GUIDANCE SYSTEM

(71) Applicant: Continental Reifen Deutschland GmbH, Hannover (DE)

(72) Inventor: Jasen Ratajczak, Fort Mill, OH (US)

(73) Assignee: Continental Reifen Deutschland GmbH, Hannover (DE)

(21) Appl. No.: 19/170,290

(22) Filed: Apr. 4, 2025

Related U.S. Application Data
(60) Provisional application No. 63/575,331, filed on Apr. 5, 2024.

(51) Int. Cl. B60C 23/04

(52) U.S. Cl. CPC B60C 23/0455; B60C 23/0484

(57) ABSTRACT

A retread guidance system is disclosed, comprising sensors coupled to a tire for measuring temperature and pressure, and a memory storing logs for temperature, pressure, and tire events. A controller with processors detects pressure and temperature events, logs them to the respective logs, and determines retread suitability for a tire casing based on the logs and retread factors.

### FIELD

The field to which the disclosure relates is tire and tire retreading.

### BACKGROUND

The subject matter related generally to tires and tire retreading.

### BRIEF DESCRIPTION OF THE DRAWINGS

FIG. 1 is a diagram illustrating a retread guidance system 100 in accordance with one or more embodiments.

FIG. 2 is a diagram illustrating a tire for use with the system 100 in accordance with one or more embodiments.

FIG. 3 is a cross sectional view of the tire in accordance with one or more embodiments.

FIG. 4 is a diagram illustrating a tractor-trailer tire for use with the system 100 in accordance with one or more embodiments.

FIG. 5 is a graph illustrating one or more relationships between pressure and retread.

FIG. 6 is a flowchart of an example method for providing retread guidance.

### DETAILED DESCRIPTION

The following description of the variations is merely illustrative in nature and is in no way intended to limit the scope of the disclosure, its application, or uses. The description is presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, with the understanding that a value range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one, and the singular also includes the plural unless otherwise stated.

The terminology and phraseology used herein is for descriptive purposes and should not be construed as limiting in scope. Language such as “including”, “comprising”, “having”, “containing”, or “involving”, and variations thereof, is intended to be broad and encompass the subject matter listed thereafter, equivalents, and additional subject matter not recited.

Also, as used herein, any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Existing systems for monitoring tire conditions typically involve sensors mounted on the tire to measure parameters such as temperature and pressure. These sensors are used to provide real-time data on the tire's operating conditions, allowing for timely detection of potential issues such as underinflation or overheating. However, conventional tire monitoring systems generally lack the capability to comprehensively track and analyze historical data related to tire performance over time. This limitation can hinder the ability to make informed decisions regarding tire maintenance and replacement.

In some prior approaches, tire monitoring systems have included basic data logging functionalities to record temperature and pressure readings at specific time intervals. While these systems can provide some historical data on tire conditions, they may not offer advanced analytics or predictive capabilities to assess the overall health of the tire and predict the optimal timing for retreading. As a result, there is a need for improved tire monitoring systems that can leverage historical data to enhance decision-making processes related to tire maintenance and retreading.

Moreover, traditional methods for determining the need for retreading a tire casing have often relied on manual inspections or subjective assessments based on visual cues. These methods may lack precision and consistency, leading to suboptimal retread decisions that can impact tire performance and longevity. Therefore, there is a demand in the industry for innovative retread guidance systems that can integrate historical temperature and pressure data with predefined retread factors to automate the retread determination process and improve the overall efficiency and effectiveness of tire maintenance practices. However, none of these approaches have provided a comprehensive solution that combines the features described in this disclosure.

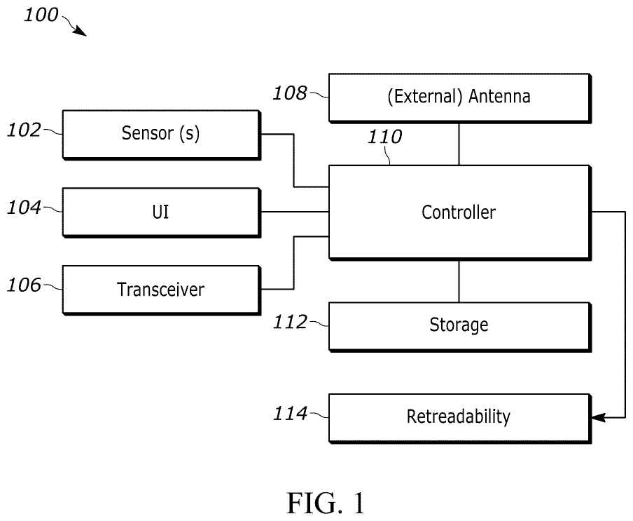

FIG. 1 is a diagram illustrating a retread guidance system 100 in accordance with one or more embodiments. The system 100 is provided for illustrative purposes and suitable variations are contemplated.

The system 100 provides guidance 114 on retread uses or applications for one or more tires.

The system 100 includes sensors 102, an interface 104, a transceiver 106, an antenna 108, a controller 110, storage or memory 112.

The sensors 102 include one or more of temperature sensors, tire cavity temperature sensors, tire tread temperature sensors, tire cavity pressure sensors and the like. It is appreciated the sensors 102 can also include light/radiation sensors to measure exposure to sunlight and the like, vibration sensors, accelerometers, location or position sensors (GPS), and the like.

The sensors 102 can be embedded or located within one or more tires, embedded within the tread, attached to a truck trailer, attached to a truck and the like.

The interface 104 can include and/or connect to a display, input device, data transfer connection, network interface, user interface, and the like.

The transceiver 106 receives sensor measurements from the sensors 102. In one example, the transceiver 106 is located on a truck.

The antenna 108 facilitates transfer of data from the sensors 102 to the controller 110. In one example, the antenna 108 forwards sensor data from the sensors 102 to the controller 110 via the transceiver 106.

The storage 112 stores the sensor data, the retread 114 and related information. The storage 112 can be integrated with the controller 110 and/or sensors 102. Alternately, the storage 112 can be remotely located.

The storage 112 can comprise various types of memory or storages, such as random access memory (RAM), volatile memory, non-volatile memory, drives, registers and the like.

The controller 110 receives the sensor data from the sensors 102. Additionally, the controller 110 can detect events, such tire pressure below a threshold value including duration of time below the threshold value.

The controller 110 can also use other information, such as location, altitude, retread cycles, tire size parameters, load or weight and the like. This other information, the sensor data, tracked events, casing age, retread operations performed and the like are used as retread factors. Thus, the controller 110 uses the retread factors to determine whether a casing of a tire can be retreaded and what use it can perform, such as drive, steer, and trailer.

It is appreciated that tire inflation pressure impacts the retread of a tire. An underinflated tire can substantially degrade a casing of a tire and prevent or limit retreading. Additionally, temperatures, such as temperatures exceeding 120 to 160 degrees Fahrenheit (49 to 71 degrees Celsius), can prematurely degrade the casing. Low temperatures, such as temperatures below 32 degrees Fahrenheit, can cause tread and casings to be brittle and susceptible to damage.

Excessive temperatures for short durations (i.e., less than 3 seconds) typically indicate braking. Excessive temperatures for longer durations typically indicate excessive speed and/or underinflation.

The retread guidance 114 includes an indication of the suitability of the casing for retread. This can include a likelihood of a successful retread process, expected or predicted lifetime of the resulting retread and the like.

The retread guidance 114 includes high tread depth (High TD) drive, low tread depth (Low TD) drive, steering, trailer, and the like and is determined based on the retread factors.

Additionally, the guidance 114 can include drive, trailer and other patterns to determine with the retread factors what would be the suitable fit for a target application or wheel position.

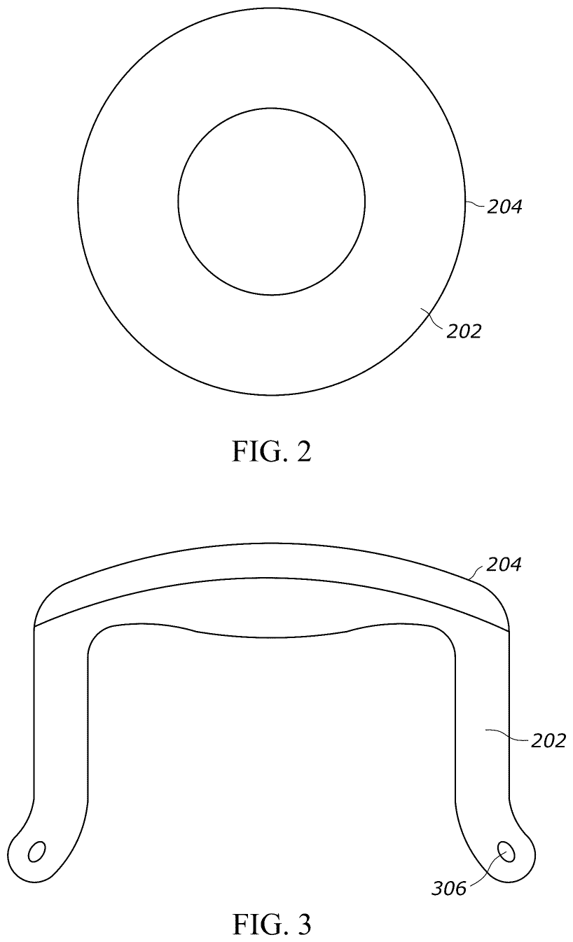

FIG. 2 is a diagram illustrating a tire for use with the system 100 in accordance with one or more embodiments. The system is provided for illustrative purposes and suitable variations are contemplated.

The tire includes a casing 202 and a tire tread 204.

The casing 202 is a core of the tire and typically constitutes 75 percent or more of a tire cost. The casing 202 can include belts, belt bandages, bead regions, carcass and the like. The tread 204 includes a ground contact portion of the tire. The tread 204 provides traction. The tread 204 can degrade or wear down over time and can be replaced by retreading.

FIG. 3 is a cross sectional view of the tire in accordance with one or more embodiments.

This view shows the casing 202 and the tread 204. Additionally, the tire is shown with a bead or bead region 306, where the tire sets against a wheel rim.

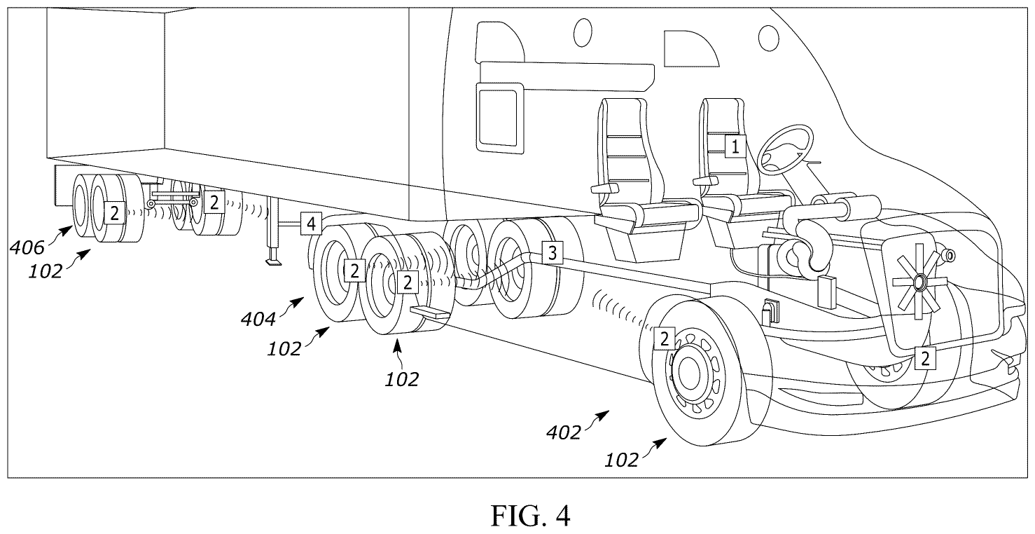

FIG. 4 is a diagram illustrating a tractor-trailer tire for use with the system 100 in accordance with one or more embodiments. The system is provided for illustrative purposes and suitable variations are contemplated.

The tractor-trailer includes a truck portion having steer wheels 402 and drive/power wheels 404. The tractor-trailer also includes a trailer portion having trailer wheels 406.

Sensors 102 can be positioned within or about the wheels 402, 404 and 406.

It is appreciated that the wheels or type of wheels have varied retread characteristics and can be considered as retread factors. For example, steer wheels can require or prohibit use of retreads whereas trailer wheels can permit multiple retreads.

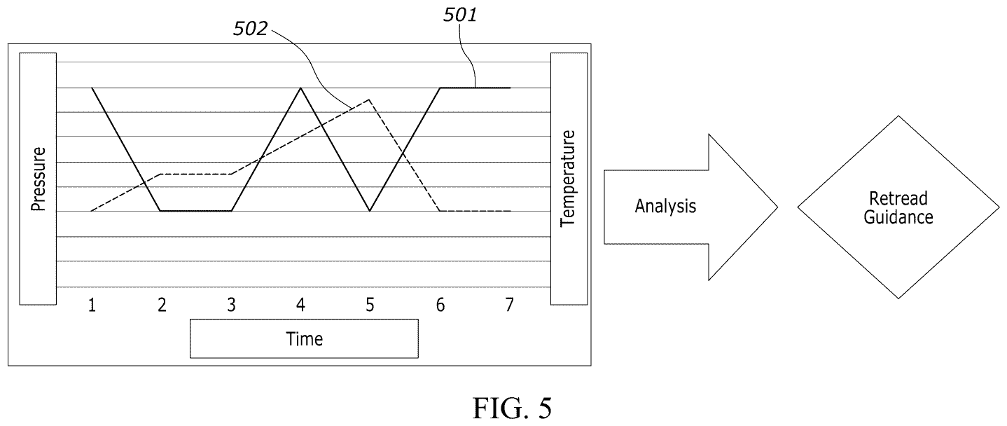

FIG. 5 is a graph illustrating one or more relationships between pressure and retread.

The graph depicts an example of temperature and pressure data over time and its application and analysis to provide retread guidance.

Line 501 shows pressure over time, essentially time of driving.

Line 502 shows tire temperature over time. It can be seen that the temperature increases and then decreases.

The analysis can include the values and the time or duration of the values.

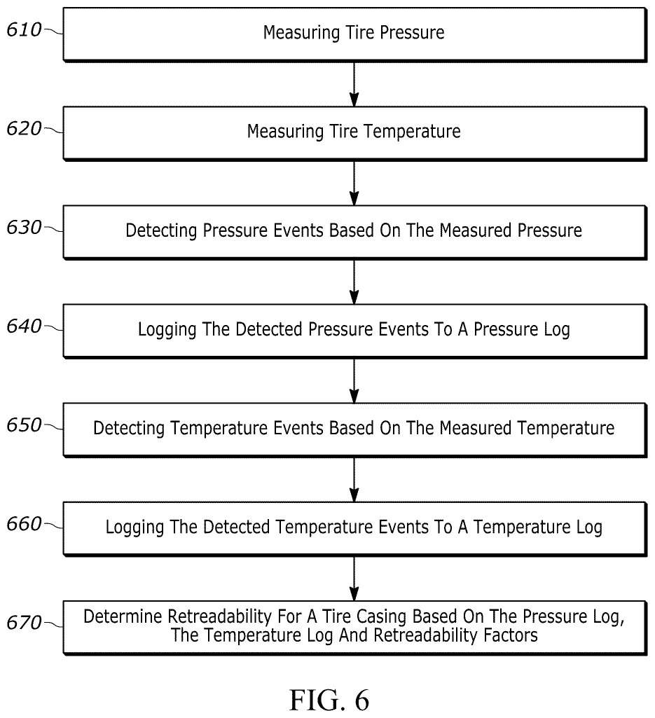

FIG. 6 is a flowchart of a method for providing retread guidance. The method is provided for illustrative purposes and it is appreciated that suitable variations are contemplated.

The retread guidance 114 includes high tread depth (High TD) drive, low tread depth (Low TD) drive, steering, trailer, and the like and is determined based on the retread factors. Additionally, the guidance 114 can include drive, trailer and other patterns to determine with the retread factors what would be the suitable fit for a target application or wheel position.

The method can be performed in conjunction with the system 100 and variations thereof.

At step 610, tire pressure is measured.

At step 620, tire temperature is measured.

At step 630, detecting pressure events based on the measured pressure.

At step 640, logging the detected pressure events to a pressure log.

At step 650, detecting temperature events based on the measured temperature.

At step 660, logging the detected temperature events to a temperature log.

At step 670, determine retread for a tire casing based on the pressure log, the temperature log and retread factors.

The foregoing description of the embodiments has been provided for purposes of illustration and description. Example embodiments are provided so that this disclosure will be sufficiently thorough and will convey the scope to those who are skilled in the art. Numerous specific details are set forth such as examples of specific components, devices, and methods, to provide a thorough understanding of embodiments of the disclosure but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Examples can include subject matter such as a method, means for performing acts or blocks of the method, at least one machine-readable medium including instructions that, when performed by a machine cause the machine to perform acts of the method or of an apparatus or system for concurrent communication using multiple communication technologies according to embodiments and examples described herein.

In some aspects, the techniques described herein relate to a retread guidance system including: one or more sensors 102 coupled to a tire to provide sensor measurements that include a measured temperature and a measured pressure; a memory 112 that maintains a temperature log for the tire, a pressure log for the tire, and an event log for the tire; a controller having one or more processors configured to: detect pressure events based on the measured pressure; log the detected pressure events to the pressure log; detect temperature events based on the measured temperature; log the detected temperature events to the temperature log; and determine retread guidance for a tire casing of the tire based on the pressure log, the temperature log and retread factors, and the sensor measurements.

In some aspects, the techniques described herein relate to a system, wherein the retread factors include width, aspect ratio, construction type and diameter of the tire.

In some aspects, the techniques described herein relate to a system, wherein the retread factors include radial, bias-ply, low profile and high profile.

In some aspects, the techniques described herein relate to a system, the detected pressure events include pressure below a recommended pressure threshold and duration of time below the threshold.

In some aspects, the techniques described herein relate to a system, the controller further configured to detect a tire event based on the provided sensor measurements.

In some aspects, the techniques described herein relate to a system, the one or more sensors attached to an inner surface of the casing.

In some aspects, the techniques described herein relate to a system, the one or more sensors including an air pressure sensor to measure an inner air pressure of the casing.

In some aspects, the techniques described herein relate to a system, the one or more sensors including a temperature sensor embedded in a tread of the tire.

In some aspects, the techniques described herein relate to a system, the one or more sensors including a temperature sensor proximate a tread of the tire to measure a tread tire temperature.

In some aspects, the techniques described herein relate to a system, the sensor measurements further including a ground contact surface of the tire.

In some aspects, the techniques described herein relate to a system, further including a transceiver to provide the retread guidance wirelessly.

In some aspects, the techniques described herein relate to a system, wherein the tire is one of a steer wheel, drive wheel, and trailer wheel.

In some aspects, the techniques described herein relate to a system, wherein the controller is located within a bead region of a tire.

In some aspects, the techniques described herein relate to a system any one, wherein the controller is located on a trailer.

In some aspects, the techniques described herein relate to a method for providing retread guidance, the method including: measuring tire pressure; measuring tire temperature; detecting pressure events based on the measured pressure; logging the detected pressure events to a pressure log; detecting temperature events based on the measured temperature; logging the detected temperature events to a temperature log; determining retread guidance for a tire casing based on the pressure log, the temperature log and retread factors.

In some aspects, the techniques described herein relate to a method, further including determining a number of prior retreads of the tire casing.

In some aspects, the techniques described herein relate to a method, determining the retread guidance further includes analyzing the number of prior retreads of the tire casing.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an Application Specific Integrated Circuit, a Digital Signal Processor, a Field Programmable Gate Array, a Programmable Logic Controller, a Complex Programmable Logic Device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second”, and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “adjacent”, “outer”, “beneath”, “below”, “lower”, “above”, “upper”, and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Clause 1. A retread guidance system comprising: one or more sensors 102 coupled to a tire to provide sensor measurements that include a measured temperature and a measured pressure; a memory 112 that maintains a temperature log for the tire, a pressure log for the tire, and an event log for the tire; a controller having one or more processors configured to: detect pressure events based on the measured pressure; log the detected pressure events to the pressure log; detect temperature events based on the measured temperature; log the detected temperature events to the temperature log; and determine retread guidance for a tire casing of the tire based on the pressure log, the temperature log and retread factors, and the sensor measurements.

Clause 2. The system of clause 1, wherein the retread factors include width, aspect ratio, construction type and diameter of the tire.

Clause 3. The system of any one of clauses 1-2, wherein the retread factors include radial, bias-ply, low profile and high profile.

Clause 4. The system of any one of clauses 1-3, the detected pressure events include pressure below a recommended pressure threshold and duration of time below the threshold.

Clause 5. The system of any one of clauses 1-4, the controller further configured to detect a tire event based on the provided sensor measurements.

Clause 6. The system of any one of clauses 1-5, the one or more sensors attached to an inner surface of the casing.

Clause 7. The system of any one of clauses 1-6, the one or more sensors comprising an air pressure sensor to measure an inner air pressure of the casing.

Clause 8. The system of any one of clauses 1-7, the one or more sensors comprising a temperature sensor embedded in a tread of the tire.

Clause 9. The system of any one of clauses 1-8, the one or more sensors comprising a temperature sensor proximate a tread of the tire to measure a tread tire temperature.

Clause 10. The system of any one of clauses 1-9, the sensor measurements further comprising a ground contact surface of the tire.

Clause 11. The system of any one of clauses 1-10, further comprising a transceiver to provide the retread guidance wirelessly.

Clause 12. The system of any one of clauses 1-11, wherein the tire is one of a steer wheel, drive wheel, and trailer wheel.

Clause 13. The system of any one of clauses 1-12, wherein the controller is located within a bead region of a tire.

Clause 14. The system any one of clauses 1-13, wherein the controller is located on a trailer.

Clause 15. A method for providing retread guidance, the method comprising: measuring tire pressure; measuring tire temperature; detecting pressure events based on the measured pressure; logging the detected pressure events to a pressure log; detecting temperature events based on the measured temperature; logging the detected temperature events to a temperature log; determining retread guidance for a tire casing based on the pressure log, the temperature log and retread factors.

Clause 16. The method of clause 15, further comprising determining a number of prior retreads of the tire casing.

Clause 17. The method of any one of clauses 15-16, determining the retread guidance further comprises analyzing the number of prior retreads of the tire casing.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A retread guidance system comprising:
one or more sensors 102 coupled to a tire to provide sensor measurements that include a measured temperature and a measured pressure;
a memory 112 that maintains a temperature log for the tire, a pressure log for the tire, and an event log for the tire;
a controller having one or more processors configured to:
detect pressure events based on the measured pressure;
log the detected pressure events to the pressure log;
detect temperature events based on the measured temperature;
log the detected temperature events to the temperature log; and
determine retread guidance for a tire casing of the tire based on the pressure log, the temperature log and retread factors, and the sensor measurements.

2. The system of claim 1, wherein the retread factors include width, aspect ratio, construction type and diameter of the tire.

3. The system of claim 1, wherein the retread factors include radial, bias-ply, low profile and high profile.

4. The system of claim 1, the detected pressure events include pressure below a recommended pressure threshold and duration of time below the threshold.

5. The system of claim 1, the controller further configured to detect a tire event based on the provided sensor measurements.

6. The system of claim 1, the one or more sensors attached to an inner surface of the casing.

7. The system of claim 1, the one or more sensors comprising an air pressure sensor to measure an inner air pressure of the casing.

8. The system of claim 1, the one or more sensors comprising a temperature sensor embedded in a tread of the tire.

9. The system of claim 1, the one or more sensors comprising a temperature sensor proximate a tread of the tire to measure a tread tire temperature.

10. The system of claim 1, the sensor measurements further comprising a ground contact surface of the tire.

11. The system of claim 1, further comprising a transceiver to provide the retread guidance wirelessly.

12. The system of claim 1, wherein the tire is one of a steer wheel, drive wheel, and trailer wheel.

13. The system of claim 1, wherein the controller is located within a bead region of a tire.

14. The system of claim 1, wherein the controller is located on a trailer.

15. A retread guidance system comprising:
one or more sensors coupled to a tire to provide sensor measurements that include a measured temperature and a measured pressure;
a memory that maintains a temperature log for the tire, a pressure log for the tire, and an event log for the tire;
a controller having one or more processors configured to:
detect pressure events based on the measured pressure;
log the detected pressure events to the pressure log;
detect temperature events based on the measured temperature;
log the detected temperature events to the temperature log; and
determine retread guidance for a tire casing of the tire based on the pressure log, the temperature log and retread factors, and the sensor measurements;
a sensor of the one or more sensors attached to an inner surface of the casing;
an air pressure sensor of the one or more sensors to measure an inner air pressure of the casing
a temperature sensor of the one or more sensors embedded in a tread of the tire;
a transceiver to provide the retread guidance;

16. The system of claim 15, wherein the retread factors include radial, bias-ply, low profile and high profile.

17. The system of claim 15, wherein the controller is located within a bead region of a tire.

18. A method for providing retread guidance, the method comprising:
measuring tire pressure by a tire pressure sensor;
measuring tire temperature at a tread by a temperature sensor;
detecting pressure events based on the measured pressure;
logging the detected pressure events to a pressure log;
detecting temperature events based on the measured temperature;
logging the detected temperature events to a temperature log; and
determining retread guidance for a tire casing based on the pressure log, the temperature log and retread factors.

19. The method of claim 18, further comprising determining a number of prior retreads of the tire casing.

20. The method of claim 19, wherein determining the retread guidance further comprises analyzing the number of prior retreads of the tire casing.
